(19) United States
(12) Patent Application Publication
(10) Pub. No.: US 2013/0151317 A1
(43) Pub. Date: Jun. 13, 2013

(54) Model and System for Service Provisioning Lifecycle Management

(71) Applicants: Anis Charfi, Darmstadt (DE); Alistair Barros, Brisbane (AU); Uwe Kylau, Brisbane (AU); Heiko Witteborg, Griesheim (DE)

(72) Inventors: Anis Charfi, Darmstadt (DE); Alistair Barros, Brisbane (AU); Uwe Kylau, Brisbane (AU); Heiko Witteborg, Griesheim (DE)

(73) Assignee: SAP AG, Walldorf (DE)

(21) Appl. No.: 13/324,369

(22) Filed: Dec. 13, 2011

(51) Int. Cl. G06Q 10/06

(52) U.S. Cl. 705/7.36

(57) ABSTRACT

Implementations of the present disclosure include methods for lifecycle management of services provisioned in a business network that include actions of defining a service package associated with a service, the service package being a logical representation of the service and including a plurality of artifacts, storing the service package in computer-readable memory, defining a service lifecycle model associated with the service, the service lifecycle model including a plurality of states, storing the service lifecycle model in the computer-readable memory, determining that the service is in a first state, determining that a first set of provisioning activities has occurred, in response to determining that the first set of provisioning activities has occurred, transitioning the service lifecycle model from the first state to a second state, and updating the service lifecycle model in the computer readable memory.

### BACKGROUND

Services utilized in large enterprises may exist in any number of forms, including multi-vendor suite solutions, home-grown applications, and third-party business process outsourcing (BPO) solutions, all of which can operate within complex information technology (IT) landscapes and on-premise hosts. The exploitation of services in large enterprises, often termed business network transformation, can include both services that need to be outsourced and those that are insourced from the global “village.” Strategic outsourcing and insourcing of services enable businesses to operate efficiently and focus on service differentiation. Thus, the next generation of software-oriented architecture (SOA) should scale for flexible service consumption beyond organizational boundaries and current business to business (B2B) applications and into communities, ecosystems, and business networks.

In recent years, many corporate entities have launched software as a service (SaaS) “Appstores,” which provide an open-ended array of hosted applications that are sourced from the development community and can be procured as marketplace commodity services. In many cases, services in large enterprises are transactional, long-running, and have complex data dependencies across various applications. Exposing transactional services for wide commoditized use through marketplaces and hubs may require that the services execute from their secure, hosted environments, which defines the contexts of service provisioning and service provisioning management.

### SUMMARY

The present disclosure is generally directed to definitions and implementations of service provisioning lifecycle management (SPLM) for provisioning services in global business networks.

Implementations of the present disclosure include computer-implemented methods for lifecycle management of services provisioned in a business network that can include actions of defining a service package associated with a service, the service package being a logical representation of the service and including a plurality of artifacts, storing the service package in computer-readable memory, defining a service lifecycle model associated with the service, the service lifecycle model including a plurality of states, storing the service lifecycle model in the computer-readable memory, determining that the service is in a first state, determining that a first set of provisioning activities has occurred, in response to determining that the first set of provisioning activities has occurred, transitioning the service lifecycle model from the first state to a second state, and updating the service lifecycle model in the computer readable memory.

These and other implementations may each optionally include one or more of the following features. For instance, the first state includes at least one of a failed state, a rejected state, a lodged state, a registered state, a brokered state, a gatewayed state, a cloud-hosted state, and a channeled state; the second state includes a consumable state, in which the service is accessible to one or more end users over one or more networks; one or more user roles are associated with the first state, one or more users associated with each user role performs the first set of provisioning activities; the one or more user roles include a service provider role, a service hoster role, a service gateway provider role, a service broker role, and a service channel maker role; the first state includes the lodged state, the first set of provisioning activities includes acceptance of the service package and the second state comprises the registered state; the first state includes the registered state, the first set of provisioning activities includes on-boarding the service package and enriching the service package with business delivery functions, and the second state includes the brokered state; actions further include determining that a second set of provisioning activities has occurred, and, in response to determining that the second set of provisioning activities has occurred, transitioning the service lifecycle model to the first state; the first state includes a lodged state and the second set of provisioning activities includes assembling the service package, and uploading the service package to computer-readable storage associated with a service broker; the artifacts include at least one of a service description, implementation artifacts, interface descriptors, policies, service level agreements (SLAs), and deployment descriptors; the deployment descriptors include at least one of delivery descriptors, gatewaying descriptors, cloud deployment descriptors, and channeling descriptors; the first state includes a lodged state, the first set of provisioning activities include determining that the service package does not conform to one or more requirements or standards, and the second state includes one of a rejected state and a failed state; actions further include executing a service provisioning management tool using the one or more processors, and receiving user input from a service provider associated with the service, wherein the service lifecycle model is transitioned from the first state to the second state further in response to the user input; and the service provisioning management tool includes one or more of a provisioning cockpit, a state-specific checklist, and a provisioning navigator.

The present disclosure also provides a computer-readable storage medium coupled to one or more processing devices and having instructions stored thereon which, when executed by the one or more processing devices, cause the one or more processing devices to perform operations in accordance with implementations of the methods provided herein.

The present disclosure further provides a system for implementing the methods provided herein. The system includes one or more processing devices, and a computer-readable storage medium coupled to the one or more processing devices having instructions stored thereon which, when executed by the one or more processing devices, cause the one or more processing devices to perform operations in accordance with implementations of the methods provided herein.

It is appreciated that methods in accordance with the present disclosure can include any combination of the aspects and features described herein. That is to say that methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can execute implementations of a service delivery framework (SDF).

FIG. 2 is a block diagram of an example SDF.

FIG. 3 depicts an abstract view of an example SDF.

FIG. 4 is a state diagram of an example service provisioning lifecycle (SPL) model for service provisioning lifecycle management (SPLM) in an SDF.

FIG. 5 is a flowchart of an example SPLM process that can be implemented in accordance with the present disclosure.

FIG. 6 is a flowchart of an example SPLM process that can be implemented in accordance with the present disclosure.

FIG. 7 is a flowchart of an example SPLM process that can be implemented in accordance with the present disclosure.

FIG. 8 a flowchart of an example SPLM process that can be implemented in accordance with the present disclosure.

FIG. 9 depicts a screenshot of an example SPLM tool.

FIG. 10 is a schematic illustration of example computer systems that can be used to execute implementations of the present disclosure.

Like reference symbols in the various drawings indicate like elements.

### DETAILED DESCRIPTION

Implementations of the present disclosure are generally directed to service provisioning lifecycle management (SPLM) for provisioning services in global business networks. A service provisioning lifecycle (SPL) can include all activities (i.e., service delivery and service consumption activities) related to the provisioning of a service into a business network. The process of enabling the delivery and consumption, subsequent to the service engineering (e.g., creation and testing of the service) is the focus of the SPLM. The SPL involves multiple provisioning partners and can be managed using an appropriate SPLM tool. In some implementations, the SPL begins when a service provider prepares a service to be exposed from its internal environment into a targeted business network and ends when the service becomes accessible to an end user. Furthermore, during the SPL, several different versions of the originally assembled service may be generated by one or more provisioning partners before the service is ultimately made accessible to an end user.

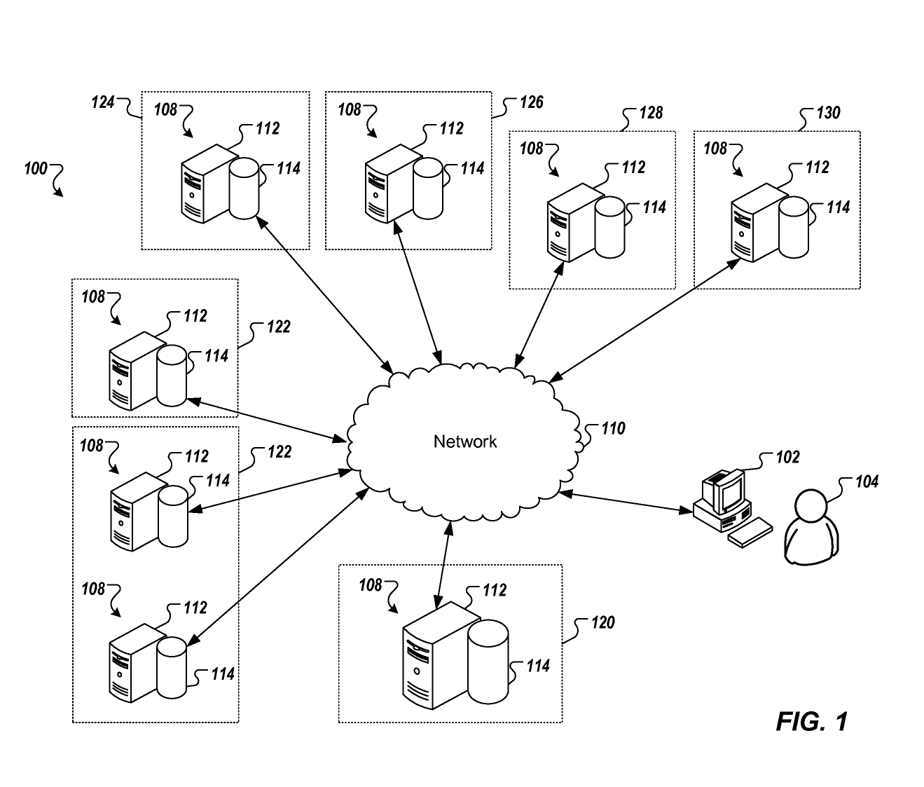

FIG. 1 depicts an example system architecture 100 that can execute implementations of SPLM. The system architecture 100 can include a client computing device 102 associated with a user 104 and computer systems 108. The client computing device 102 can communicate with one or more of the computer systems 108 over a network 110. The computer systems 108 can communicate with each other and/or the client computing device 102 over the network 110. The computer systems 108 can each include one or more servers 112 and one or more datastores 114. In some implementations, the system architecture 100 may represent a client/server system supporting multiple computer systems (e.g., computer systems 108) including one or more clients (e.g., client computing device 102) that are connectively coupled for communication with one another over the network 110.

The client computing device 102 can represent various forms of processing devices including, but not limited to, a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. The client computing device 102 may access application software on one or more of the computer systems 108.

The computer systems 108 can represent various forms of server systems including, but not limited to a web server, an application server, a proxy server, a network server, or a server farm. For example, one or more of the servers 112 can be an application server that executes software accessed by the client computing device 102. In some implementations, a user can invoke applications available on one or more of the servers 108 in a web browser running on a client (e.g., client computing device 102). Each application can individually access data from one or more repository resources (e.g., datastores 114).

In some implementations, the client computing device 102 may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such Bluetooth, WiFi, or other such transceiver communications.

The network 110 can be a large computer network, such as a local area network (LAN), wide area network (WAN), the Internet, a cellular network, or a combination thereof connecting any number of mobile clients, fixed clients, and/or servers. In some implementations, each client (e.g., client computing device 102) can communicate with one or more of the computer systems 108 via a virtual private network (VPN), Secure Shell (SSH) tunnel, or other secure network connection. In some implementations, the network 110 can include the Internet, a wireless service network and may include the Public Switched Telephone Network (PSTN). In other implementations, the network 110 may include a corporate network (e.g., an intranet) and one or more wireless access points.

The client computing device 102 can establish its own session with the computer systems 108. Each session can involve two-way information exchange between the computer systems 108 and the client computing device 102. For example, a Hypertext Transfer Protocol (HTTP) session can allow the association of information with individual users. A session can be a stateful session, in which at least one of the communicating parts (e.g., the computer systems 108 or the client computing device 102) stores information about the session history in order to be able to communicate. Alternatively, stateless communication during a stateless session includes independent requests with associated responses.

The example architecture 100 can be used to realize implementations of SPLM in accordance with the present disclosure. For example, the client computing device 102 and/or the user 104 may be a service consumer that accesses and uses one or more services provided by the SPL. As discussed in further detail herein, the SPL involves a service broker 120, one or more service providers 122, one or more service aggregators 124, one or more service channel makers 126, one or more service hosters 128, and one or more service gateways 130.

The service broker 120 can be provided by a brokerage entity. Functionality of the service broker 120, discussed in further detail herein, can be realized using one or more computer systems 108, for example. The one or more service provides 122 can include corresponding service provider entities. Functionality of the service providers 122, discussed in further detail herein, can be realized using one or more computer systems 108, for example. The one or more service aggregators 124 can include corresponding service aggregator entities. Functionality of the service aggregators 124, discussed in further detail herein, can be realized using one or more computer systems 108, for example. The one or more service channel makers 126 can include corresponding service channel maker entities. Functionality of the service channel makers 126, discussed in further detail herein, can be realized using one or more computer systems 108, for example. The one or more service hosters 128 can include corresponding service hoster entities. Functionality of the service hosters 128, discussed in further detail herein, can be realized using one or more computer systems 108, for example. The one or more service gateways 130 can include corresponding service gateway entities. Functionality of the service gateways 130, discussed in further detail herein, can be realized using one or more computer systems 108, for example.

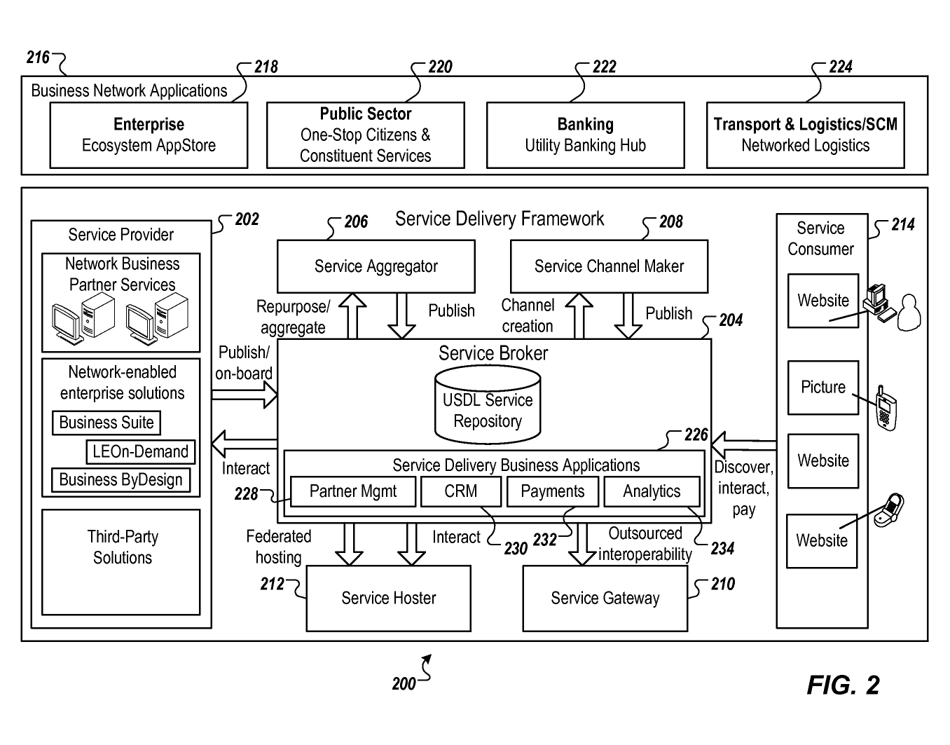

FIG. 2 is a block diagram of an example service delivery framework (SDF) 200. The SDF 200 supports a variety of provisioning partners as seen through different roles. In some implementations, the roles include service provider 202, service broker 204, and service aggregator 206. The SDF 200 further includes service channel maker 208, service gateway 210, service hoster 212 and service consumer 214. Different provisioning partners can use particular platform functionalities dedicated for their service provisioning niches, as discussed in further detail below. The functionality offered through the SDF roles combines technical capabilities (e.g. service composition tools, service repository, service adaptation and runtime environment, and network convergence) with business functionality (e.g. customer relations management (CRM) and payments) for supporting various forms of service delivery. Service delivery can be drawn from a foundation layer of components accessed through a service-oriented architecture (SOA) enabled business process platform.

In some implementations, an architectural strategy for the SDF 200 recognizes that industry-specific applications 216 may be needed for business networks operating in different industries. Example applications that apply to industry-specific business networks (e.g., eGovernment platforms for one-stop citizens and constituent services) can provide user interfaces (UIs) and logic that, while coded against a generic SPL layer, are specific to particular domains. Example applications can include enterprise applications 218, public sector applications 220, banking applications 222, and transport and logistics applications 224. In some implementations, the applications can be separately deployed as on-premise installations for customers. In some implementations, the applications can be run as on-demand for several customers. Because a variety of domains are targeted, the SDF 200 supports diverse services and diverse consumption modes.

The service provider 202 supports partners that hold governance and operational responsibility for services through their business operations, business processes, and organizational units, as well as systems and other implementation artifacts. Each service provider 202 provides the dedicated tooling to engineer, expose, and interface services, whether the services be from scratch or from existing applications. For example, the service provider 202 supports companies that service-enable their applications by allowing the functional dependencies of applications to be visualized, analyzed for coupling and cohesion, and assessed for the costs and feasibility of a service interface layer. For example, representational state transfer (REST) style interfacing can be introduced as a layer over applications that are difficult to decouple. As another example, Web service description language (WSDL) interfaces can be generated for parts of applications that can be decoupled.

Each service provider 202 exposes services to a business network so that the services can be accessed without compromise to the mechanisms put in place by providers for service delivery. For example, a service provider should be able to publish a service to a third-party broker, while still requiring that the service run through the current hosting environment and be interacted with through a secure gateway. Some service providers may loosen constraints to access by allowing services to be re-hosted onto a third-party cloud, or downloaded and run in the environment of a service consumer. In such a case where the service is accessed through a third-party, the service provider 202 can ensure that the service is comprehensively described, at least for the benefit of service consumers 214. Such descriptions can include, for example, service ownership, functional descriptions, dependencies on other services, pricing, and consumer rights, penalties, and obligations in terms of service performance, exceptions, information disclosure, and other legal aspects. For services related in wider business contexts, domain-specific semantic descriptions, vertical industry standards and other documents containing service-related information (e.g., policy, legislation and best practices documents) are also useful in enhancing service discovery and consumer comprehension of services. Such comprehensive descriptions can be linked to service descriptions and can be used during service discovery and access through unstructured search techniques.

Each service provider 202 interacts with the service broker 204 to publish or on-board service details so that they can be accessed through the service broker 204. Thus, the service broker 204 exposes services from the service providers 202 and offers delivery components including non-functional aspects of the service delivery (e.g., authentication, metering, or payment) and manages the service delivery. Example service details can include descriptions, execution artifacts and the like. As discussed in further detail herein, the service broker 204 is the central point of service access within the SDF 200. Each service provider 202 supports provider environments so that the services they host can be integrated with the service broker 204 for required inbound and outbound run-time interactions. The service providers 202 allow deployment of standard provider interfaces in provider environments. In this manner, interactions from the service broker 204 are guarded against security risks and convoluted logic of hosted service applications. Further, service providers 202 have well-defined and allowable operations exposed to them for interacting with the service broker 204.

The service broker 204 supports brokerage agencies that specialize in exposing services from diverse service providers 202 into new markets, matching consumer requests with capabilities of services advertised through the service broker 204. These brokerage agencies manage the “front-desk” delivery of services to consumers, without assuming “back-office” responsibility. Although services are accessed through the service broker 204, execution of the core parts of the services resides elsewhere in a hosted environment. The benefits for service providers 202 lie in reduced costs from outsourced delivery as well as exposure to new markets created by the service broker 204. The service broker 204 can enhance consumer pull through cost-offsets of advertisers, market analysts and other entities that benefit from making their businesses visible through other services.

The service broker 204 is central to the SDF 200 and is used to expose services from the service providers 202. The services can be on-boarded and delivered through the service delivery functionality of the service broker. Example service delivery functionality includes run-time service access, billing/invoicing, and metering. Services consumed through end users or applications or services offered in a business network through intermediaries like cloud providers and B2B gateways can each be published in the service broker 204. Third-parties can extend and repurpose services through the service broker 204. For example, a service aggregator 206 can use the directory facilities of the service broker 204 to discover and make use of services through design-time tooling, as discussed in further detail below. Ultimately service delivery is managed through the service broker 204 when services are accessed at run-time by service consumers 214. As discussed in further detail herein, example service consumers 214 can include end users, applications, and business processes. In short, the service broker 204 provides a directory and delivery resource for service access.

To support different needs, the service broker enables service providers 202 to specify different delivery models. The delivery models can constrain the way a service is accessed at run-time. Based on delivery needs, the service broker 204 generates the delivery logic, alleviating service providers 202 with the burden of developing and maintaining delivery logic. Example delivery models can include offline delivery, download delivery, reference delivery, and mediated delivery. Offline delivery can correspond to ordering professional, human services without any run-time execution, and download delivery can correspond to downloading services to run on a client environment. Reference delivery can correspond to direct access to service endpoints in their backend environments, and mediated delivery can correspond to managed access for individual service steps through an intermediary. The service broker 204 is also equipped with service delivery business applications 226 to support service delivery on a business level. Example service delivery applications 226 can include a partner management application 228, a customer relationship management (CRM) application 230, a payments application 232, and an analytics application 234.

The service hoster 212 enables the various infrastructure services in cloud environments to be leveraged as part of provisioning an application in a business network. Thus, the service hoster 212 provides access to (usually virtualized) platform and infrastructure resources on which a service can be hosted. By way of non-limiting example, enterprise resource planning (ERP) suites can include certain types of services that can be re-hosted from their on-premise environments to cloud-based, on-demand environments. In this manner, such services could attract new users at much lower cost without the overhead of requiring access to large application back-ends. As one example, a business network could expand sales lines by allowing small and medium enterprises (SMEs) to access a low-cost, cloud-based order-to-cash service that is integrated with on-premise ERP systems of larger companies.

A service can be automatically deployed onto a specific cloud using an interface provided by the service hoster 212. By providing a generic interface for infrastructure services, the service hoster 212 opens up the possibility to access multiple cloud providers through the same service hoster interface. This can be significant for business networks because cloud services are highly commoditized with slim margins and are subject to business volatility. The service hoster 212 offers business network partners the possibility to shift cloud providers efficiently, avoiding cloud “lock-in.” Cloud services exposed to a business network can plug-in to the service hoster 212 and can be advertised through the service broker 212.

When a service is to be hosted, the service broker 204 can match hosting requirements with cloud services that have the required virtual machines. Example hosting requirements can include platform service requirements and operating system requirements. The service broker 204 performs the matching and lists candidate cloud services for a user. An example user can include a service provider requiring hosting as a part of exposing a service offer in a business network or a service consumer negotiating hosting options/costs when a service is ordered. To deploy a service into the selected cloud service of choice, the virtualization management interface of the service hoster allows for interaction with specific cloud services. Once hosted, the cloud service may be monitored for performance and reliability through the service hoster interface. Monitoring information can be streamed through this interface to the service provider 202.

The service gateway 210 supports agencies in selecting a choice of solutions that provide an economies-of-scale and B2B interoperability as a service for their applications. In some examples, the service gateway 210 is a technical intermediary that facilitates interoperability between B2B industry standards by providing adaptation between externally exposed service interfaces and internal and heterogeneous interfaces. When a service provider exposes a service onto a business network, different service versions can be created. The different services can have corresponding interfaces that enable interactions with different message standards of the partners that are allowed to interact with the service.

Distinct as well as common message standards are supported by different B2B gateway providers. The service gateway 210 enables a number of B2B gateways to be registered so that their services can be accessed through a generic interface. The B2B gateway services are advertised through the service broker 204, allowing service providers 202 to search for candidate gateway services for interface adaptation to particular message standards. Key differentiators are the pricing models, B2B communities engaging in their hubs, and qualities of service. Some gateways are evolving into suite solutions, providing common master-data and reference business processes in particular industries. Such gateways offer greater value for interoperability because interoperability occurs through a reference business process context. For design-time mapping, the service hoster 212 provides model-based tooling for adapting services, regardless of which B2B gateway provider is being used. The tooling supports automated schema matching, user-specified service-to-service associations on message type and data type levels, and automatic adaptation generation.

For run-time adaptation, B2B gateways address robustness of interactions through different mechanisms, such as by supporting integrity checking of service invocations (e.g., whether an action is allowed on a service given its current state), message correlation, fan-out/fan-in invocations (e.g., an external invocation translated to a number of service calls in different orders), and contingency handling for service invocation failures. Like the interactions between the service broker 204 and the service hoster 212, abstract interfaces are offered for engaging, interoperating, and monitoring of these types of functions across the gateway services registered with the service gateway 210.

Service aggregators 206 select services from the service broker 204 for aggregating and repurposing the services to create a new service, and essentially, a new product offering. The service aggregator 206 on-boards and deploys this new service to the service broker 204. Further, the service aggregator 206 can drive new channels from the aggregated service, targeting specialized sectors within the financial services industry, for example.

The service aggregator 206 supports domain specialists and third-parties in aggregating services for new and unforeseen opportunities and needs. In some implementations, services may be integrated into corporate solutions, creating greater value for its users not otherwise available in their applications. In some implementations, services can be aggregated as value-added, reusable services made available for wider use by business network users. In either case, the service aggregator 206 provides dedicated tooling for aggregating services at different levels (e.g., UI, service operation, business process or business object levels). Best-of-breed service aggregation tooling and techniques can be exploited through the service aggregator 206.

Service aggregators 206 are similar to service providers 202; however, there is an important difference. Service aggregators 206 do not necessarily own all of the services that they aggregate. Instead, a service aggregator 206 can obtain custodial rights from service providers 202, for example, to repurpose services, subject to usage context, cost, trust, and other factors. In some implementations, and despite new aggregated services being created, constituent services can execute within their existing environments and arrangements. In such implementations, and even though aggregated, a service can continue to be accessed through the service broker 204 based on a delivery model. The SDF 200 supports service-level agreement support through its various roles so that service providers 202 and service aggregators 206 can understand the constraints and risks when provisioning services in various situations, including aggregation of services. The service aggregator 206 provides pure design-time tooling functionality. The service aggregator 206 interacts with the service broker 204 for discovery of services to be aggregated and for publishing aggregated services for use by network partners. The service aggregator 206 also interacts with service consumers 214 when services are consumed into existing applications.

The service channel maker 208 supports agencies in creating outlets through which services are consumed. Service channel makers 208 create new customer-focused and device-specific user interfaces from the brokered service, enabling the service provider 202 to access a larger audience though a substantial variety of channels. Channels, in a broad sense, are resources, such as Web sites/portals, mobile channels, and work centers, through which services are accessed by end users. Example channels can include Internet Banking, Mobile Banking, and Retail Banking The mode of access is governed by technical channels like the Web, mobile, and voice response.

The notion of channeling has obvious resonance with service brokerage, as the majority of prominent Web-based brokers expose services for direct consumption and may also be considered as channels. The SDF 200 separates designations of the service channel, and the service broker 204 addresses an additional level of flexibility for market penetration of services. Service channels are points of service consumption, while the service broker 204 enables access of services situated between channels and hosting environments where the core parts of a service can reside. This separation enables various service UIs and channels to be created. Various channels can be created for services registered through the same service broker 204. The SDF 200, in other words, enables consolidation of service discovery and access through the service broker 204 and independent consumption points through the service channel maker. This is particularly useful for mainstream verticals like the public sector, which dedicates whole-of-government resources for service discovery and access, but requires a variety of channels for its various and emerging audiences.

The creation of a channel involves selection of services consumed through the channel, service operations that are to be used, business constraints that apply (e.g. availability constraints), and how the output of an operation should be displayed (forms template) in the channel. By way of non-limiting example and considering the structure of a Web page, service operations, along with text blocks, widgets, images, tables, and the like, would be selected into different parts of the page. Different service forms or outputs presented on the same page may require data field correlations. Web authoring applied specifically for services (e.g. requiring that service output be equivalently represented as text) can be supported through the service channel maker 208. Multi-modal interactions are also provided, featuring integrated conventional, spatial, and voice interactions.

The service channel maker 208 interacts with the service broker 204 for discovery of services during the process of creating or updating channel specifications as well as for storing channel specifications and channeled service constraints in the service broker 204. Channels can be discovered through the service broker 204 and allocated through a service consumer 214 for usage through designated users/groups in the business network.

The service consumer 214 completes the service supply chain that is effectively fostered by the SDF 200. Thus, the service consumer 214 discovers, selects, configures, negotiates, orders, and consumes the service with the goal of co-creating business value. Through the service consumer 214, parties can manage the “last mile” integration where services are consumed through different environments. This involves the allocation of resource consuming services to consumer environments in which they operate and the interfacing of consumer environments so that the services required can be accessed at run-time in a secure and reliable way.

As discussed above, the resources that consume services are either explicit channels or applications that have services integrated (“hard-wired” into code) or accessible (through a discover/access interface). The service channel maker 208 and the service aggregator 206 support the processes of design-time integration of channels and applications, respectively. Because the allocation of applications in organizations is a specialized consideration controlled through administration systems, the service consumer 214 allocates channels in consumer environments.

The service consumer 214 supports consumer environments so that the services they require are integrated with the service broker 204 through inbound and outbound run-time interactions. As discussed above, the service broker 204 enables services to be accessed through different delivery models. Interfaces are provided on remote consumer environments so that applications running in the environments have well-defined operations that allow interactions with the service broker 204. The interfaces also ensure that invocations from the service broker 204 are free from security risks and application-specific logic when interacting with consumer environments.

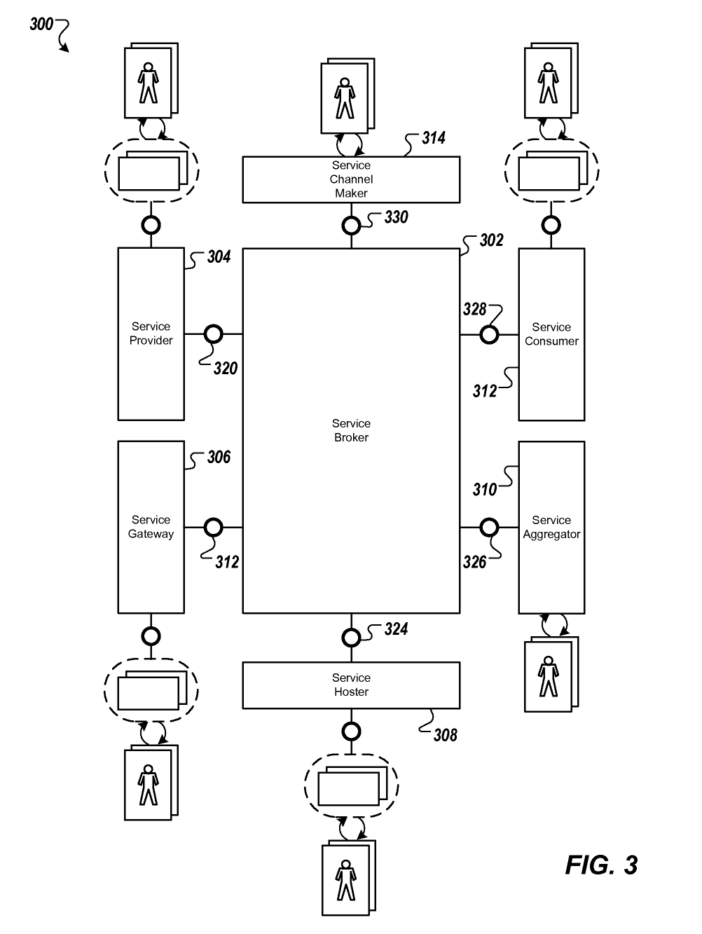

FIG. 3 illustrates an example module architecture 300. As used herein, the term module can refer to one or more software programs that receive input data, process the input data to generate output data, and provide the output data in accordance with functionality described herein. In some implementations, the modules can include one or more sub-modules that operate in concert to provide the functionality discussed herein. Each module and/or sub-module can be executed using one or more computing devices. For example, and referring again to FIG. 1, each module and/or sub-module can be executed by one or more of the client computing device 102 and the computer systems 108.

The example module architecture 300 corresponds to implementations of the SDF discussed herein, and includes a service broker module 302, one or more service provider modules 304, one or more service gateway modules 306, one or more service hoster modules 308, one or more service aggregator modules 310, one or more service consumer modules 312, and one or more service channel maker modules 314.

The service broker module 302 can include one or more modules and/or sub-modules and that can be executed using one or more computing devices (e.g., computer system 108 of FIG. 1) that communicates with each of the modules 304, 306, 308, 310, 312 and 314 over one or more networks (e.g., the network 110 of FIG. 1). The service broker module 302 can communicate with the service provider module 304 through one or more application program interfaces (APIs) 320. The service broker module 302 can communicate with the service gateway module 306 through one or more APIs 322. The service broker module 302 can communicate with the service hoster module 308 through one or more APIs 324. The service broker module 302 can communicate with the service aggregator module 310 through one or more APIs 326. The service broker module 302 can communicate with the service consumer module 312 through one or more APIs 328. The service broker module 302 can communicate with the service channel maker module 314 through one or more APIs 330.

Services may be of several forms. In some examples, services can range from fully automated services implemented in software to IT-supported services to professional human services. Accordingly, different types of services can have different types of artifacts that may be grouped within a service package, which is the logical representation of the service.

Artifacts may belong to one or more of several different categories. Unified Service Description Language (USDL) is a metadata format that unifies business, operational, and technical description aspects. USDL Service Description is a category for the set of one or more USDL documents that describe the service. In some examples, a USDL may further connect other artifacts to this information and to each other.

Implementation Artifacts is a category that includes aspects concerning the internal implementation of the core functionality of a service and the exposure of the service to the network. In some examples, Implementation Artifacts can include one or both of traditional Programming Artifacts and User Interface Artifacts. Programming Artifacts may further include one or more of code binaries/libraries, configuration files, deployment descriptors, and data-source descriptors. In some examples, Programming Artifacts can include artifact formats normally belonging to other categories, such as models of processes used to realize the internal functionality of the service. User Interface Artifacts can include any type of artifact used in rendering an interface to a user (e.g., HTML, CSS, Flash, etc.).

Interface Descriptors is a category of metadata artifacts that describe how to communicate with the service. This category includes both Structural Interface Descriptors and Behavioral Interface Descriptors. Structural Interface Descriptors are associated with accessing the service and communicating with the service. For example, Structural Interface Descriptors may describe transport protocols and message formats. In some examples, Structural Interface Descriptors may be concerned with syntactic metadata (e.g., WSDL). In some examples, Structural Interface Descriptors may be concerned with the semantics of the described concepts (e.g., WSML or OWL). In some aspects, Behavioral Interface Descriptors may be concerned with the flow of interaction between entities involved in the value co-creation process (e.g., BPEL or BPMN).

Policies and SLAs is a category including artifacts expressing non-functional information regarding with the quality and governance associated with the core functional components of the service (e.g., WS-Policy, WS-Agreement, etc.).

Deployment Descriptors is a central category that groups artifacts used to describe one or more of brokerage, gatewaying, hosting, and channeling aspects of the service deployment. Accordingly, Deployment Descriptors include Delivery Descriptors, Gatewaying Descriptors, Cloud Deployment Descriptors, and Channeling Descriptors. In some implementations, Delivery Descriptors are used by service brokers or service marketplaces to govern delivery of the service. For example, the service may be downloaded, or the service delivery can be mediated by the broker. Delivery Descriptors may further include information regarding which components offered on the broker platform are to be used to enhance the service delivery.

Gatewaying Descriptors can be used to realize B2B interoperability for the service. In some examples, Gateway Descriptors include information regarding how to adapt one or both of the structural and behavioral interface of the service. In some examples, Gateway Descriptors include information regarding deployment of these interfaces into the runtime of a B2B interoperability platform.

Cloud Deployment Descriptors describe how to deploy other artifacts of the service package into the architecture of an on-demand computing infrastructure or platform. Channeling Descriptors define how the service may be integrated into the targeted consumption environment. In some examples, Channeling Descriptors further reference several other artifacts within the service package and outline how they are plugged into extension points of the target environment.

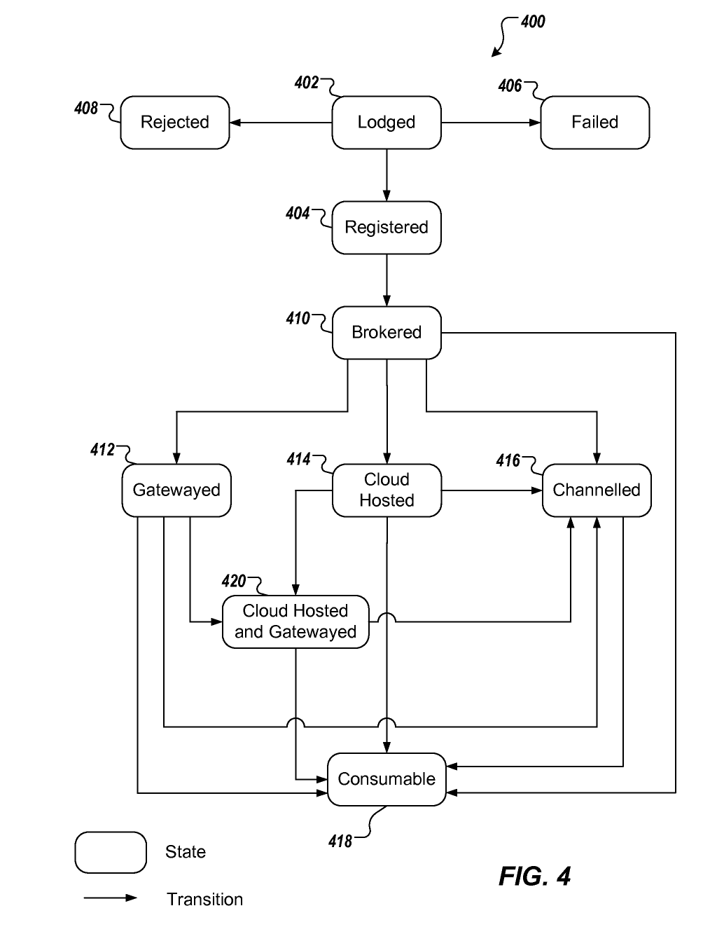

Referring now to FIG. 4, a state diagram 400 of an example service provisioning lifecycle (SPL) model for service provisioning lifecycle management (SPLM) in an SDF is depicted. The SPL model for SPLM can include several stages, or states, and transitions between states. In some implementations, a service transitions from one state to another after one or more provisioning steps have been performed. In some examples, particular users can modify particular artifacts during a state transition. In some examples, service provisioning states can include one or more of Lodged (402), Registered (404), Failed (406), Rejected (408), Brokered (410), Gatewayed (412), Cloud-hosted (414), Channeled (416), and Consumable (418). In some examples, a state can be both Gatewayed and Cloud-hosted (420) at the same time.

In the Lodged state, the service package may be assembled, uploaded, and lodged at the service broker. In some implementations, the service provider decides to initiate provisioning of the service into a service network. Provided that the service provider is registered in the network and has provisioning approval, the service provider begins to assemble the artifacts that will be uploaded and deployed on the provisioning platform of the network (usually provided by the service broker). In some examples, artifacts are readily available and may be uploaded as-is. In some examples, artifacts are prepared (e.g., revised) for exposure (e.g., USDL service description) using dedicated tooling. In some implementations, once the set of service artifacts is assembled, the service provider finalizes deployment by formally lodging the service, which transitions the service to the Lodged state. Example update semantics and users associated with the relevant artifacts at the Lodged state are listed below:

| Active | | |
|---|---|---|
| Role | Artifact | Task |
| Service | USDL Service | Create service description, define mandatory |
| Provider | Description | parameters such as name, version, nature, |
| | | capabilities, and organizational and |
| | | provisioning ownership |
| | | Specify additional service characteristics, |
| | | e.g., interaction protocol, additional |
| | | stakeholders, etc. |
| | Other artifacts | Create/add other artifacts to the service |
| | | package |

In some implementations, before provisioning continues, the service package is cleared (i.e., the service package is certified to meet the requirements and standards of the service network) by an authority of the network to which it is provisioned. In some examples, the requirements and standards can include conditions and terms of use for the service provisioning. When a lodgment request is received, the artifacts are examined according to the requirements and standards. In some examples, individual artifacts and their combination as a service package are checked for one or more of syntactic correctness, semantic consistency, and quality (which may be determined from execution tests). In some implementations, these checks may be controlled by one or more of the staff operating the provisioning platform, the service provider, and other service stakeholders. In some implementations, the checks may be performed using some degree of automation. In some examples, the staff may further confirm proper professional conduct and trustworthiness of the involved entities. Once the service package is cleared, the service is accepted by the service broker and is transitioned from the Lodged state to the Registered state.

In some examples, the lodged service package can be transitioned to the Failed state, if component errors are present within the service package. For example, the lodged service can fail the verification checks, upon which the service provider is informed of the reasons causing the failure. Minor reasons with obvious fixes (which can be detected by the checking authority) allow for re-lodgment of the corrected artifacts. However, if major flaws are detected, the lodged service may be transitioned to the Failed state.

In some examples, the lodged service can be transitioned to a Rejected state, if the service package is not accepted due to serious violations of business standards. For example, the lodged service may be rejected by the checking authority for a number of reasons (e.g., the service is fraudulent or is associated with black-listed organizations or back-office sub-providers). In this case, the lodged service is transitioned to the Rejected state. Example update semantics and users associated with the relevant artifacts at the Registered, Failed, and Rejected states are listed are listed below:

| Active | | |
|---|---|---|
| Role | Artifact | Task |
| Broker | USDL Service | Manual or automatic checks and |
| | Description | certification |
| | Service Package | Check service package for correctness |
| | | and consistency |
| Service | USDL Service | Correct service description |
| Provider | Description | |
| | Other artifacts | Complete service package |

In some implementations, the registered version of a service can be considered as a default configuration (blueprint) for further provisioning. Service providers are given the opportunity to adapt or amend this configuration to generate targeted offerings. While the registered version may be transitioned to the Brokered state without any such change, it is intended that service providers make use of the business delivery components provided by the provisioning platform. This gives the service providers the opportunity to free themselves from certain delivery functions, such as payment/billing, customer/partner management (including authentication), and service execution. Thus, the service providers can have the liberty to choose which functions they want to outsource to the provisioning platform and can accordingly configure selected delivery components according to their needs. In some examples, the service providers can perform these tasks with assistance from platform experts. Upon completion of this delivery configuration, a new provisioning version is created from the registered service, and the service is transitioned to the Brokered state. Thus, in the Brokered state, the service has been on-boarded and may be enriched with business delivery functions. Example update semantics and users associated with the relevant artifacts at the Brokered state are listed below:

| Active | | |
|---|---|---|
| Role | Artifact | Task |
| Service | Delivery | Configure delivery |
| Provider | Descriptors | |
| | USDL Service | Edit service characteristics, e.g., version, |
| | Description | provisioning stakeholders, capabilities, |
| | | pricing, legal terms, interaction protocol, |
| | | service level, etc. |
| | Other artifacts | Define Interface Descriptors |
| | | Optional: add/edit other artifacts |
| Broker | Delivery | Check delivery configuration |
| | Descriptors | |
| | Service Package | Check service package for correctness |
| | | and consistency |

In some implementations, service providers may be specialized in the adaptation of service interfaces that act as B2B interoperability gateways and offer high-performance runtime adaptation (mostly in the form of message translation and simple coordination of partner interactions). Service providers (or anyone who is authorized by the service provider) may want to use this functionality and generate an adapter in order to open new fields of use. Using dedicated tooling provided by the provisioning platform, the service provider can design an adapter for a service, select a matching interoperability gateway, configure a deployment for this combination, and repackage the adapted service. This new service may be uploaded to the provisioning platform, registered, and catalogued as a new provisioning version. Thus, the service package can be transitioned to the Gatewayed state, during which B2B interoperability specification is crated and integrated with the service. Example update semantics and users associated with the relevant artifacts at the Gatewayed state are listed below:

| Active | | |
|---|---|---|
| Role | Artifact | Task |
| Service | Gateway | Configure B2B interoperability |
| Provider | Descriptors | |
| | USDL Service | Edit provisioning stakeholders, technical |
| | Description | interface, pricing, legal terms |
| | | Edit other characteristics, e.g., version, |
| | | interaction protocol, service level, etc. |
| | Other artifacts | Add/edit other artifacts, e.g., Interface |
| | | Descriptors |
| Gateway | Gatewaying | Check gatewaying configuration |
| Partner | Descriptors | |
| | Other artifacts | Check/adapt other artifacts, e.g., Interface |
| | | Descriptors |
| | USDL Service | Check service description |
| | Description | |
| Broker | Service Package | Check service package for correctness |
| | | and consistency |

For many types of automated services, an increase in consumption means that the infrastructure maintained to operate the services is to scale up accordingly. Service providers may not have the capability to scale up and can therefore utilize virtualized computing resources offered on-demand, such as cloud computing infrastructures. Using capabilities of the provisioning platform, infrastructure requirements are matched against available cloud computing infrastructures, and a suitable candidate may be selected. Deployment configuration for the selected cloud infrastructure may be created, and the service may be hosted dynamically upon a consumer request for the service according to the configuration. The service is repackaged with the deployment configuration and uploaded to the service broker, where it is catalogued as a new provisioning version. Thus, in some implementations, the service package can be transitioned to a Cloud-hosted state, during which hosting specifications are created and integrated with the service. Example update semantics and users associated with the relevant artifacts at the Cloud-hosted state are listed below:

| Active | | |
|---|---|---|
| Role | Artifact | Task |
| Service | Hosting | Configure hosting |
| Provider | Descriptors | |
| | USDL Service | Edit provisioning stakeholders, pricing, |
| | Description | etc. Edit other characteristics, e.g., |
| | | version, technical interface, etc. |
| | Other artifacts | Add/edit other artifacts, e.g., Interface |
| | | Descriptors and Implementation Artifacts |
| Hosting | Hosting | Check hosting configuration |
| Partner | Descriptors | |
| | Other artifacts | Check/adapt other hosting-relevant |
| | | artifacts, e.g., Interface Descriptors |
| | | and Implementation Artifacts |
| | USDL Service | Check service description |
| | Description | |
| Broker | Service Package | Check service package for correctness |
| | | and consistency |

In some examples, making a service consumable to end users can range from simply downloading a file to developing a complex client application with a graphical user interface (GUI). Furthermore, the original method of access to a service may not be suitable for every consumption context. Channeling (or Channel Making) is a provisioning step that adapts a service package for consumption in new contexts (channels). In some implementations, channeling is performed by channeling partners of the service provider, who adapt existing user interfaces and other service structures to fit the targeted consumption environment. The re-factored service is repackaged and catalogued on the provisioning platform as a new provisioning version, upon which the service is transitioned to the Channeled state. Thus, once a service has transitioned to the Channeled state, it has been tailored to a particular consumption channel. Example update semantics and users associated with the relevant artifacts at the Channeled state are listed below:

| Active | | |
|---|---|---|
| Role | Artifact | Task |
| Service | Channeling | Configure channeling |
| Provider | Descriptors | |
| | USDL Service | Edit provisioning ownership, |
| | Description | provisioning stakeholders |
| | | Optional: edit other characteristics, |
| | | e.g., version, descriptions, |
| | | capabilities, interaction, etc. |
| | Other artifacts | Add/edit other artifacts, e.g., User |
| | | Interface Artifacts |
| Channel | Channeling | Check channeling configuration |
| Partner | Descriptors | |
| | User Interface | Check user interface of the service |
| | Artifacts | |
| | USDL Service | Check service description |
| | Description | |
| Broker | Service Package | Check service package for correctness |
| | | and consistency |

In a Consumable state, the service package becomes accessible to potential service consumers (end users). This state therefore includes multiple provisioning steps, such as Discovery, Selection, Configuration, Trial, Negotiation, and Ordering/Contracting. At this point, the service provider and the provisioning platform can perform the value co-creation process of the service (even though further preparation or integration tasks may be required on the consumer side). The contracted service package is listed as a consumable provisioning version. Example update semantics and users associated with the relevant artifacts at the Consumable state are listed below:

| Active | | |
|---|---|---|
| Role | Artifact | Task |
| Consumer | USDL Service | Check service description |
| Service | Description | |
| | Other artifacts | Check other artifacts, e.g., Interface |
| | | Descriptors, Policies, SLAs, etc. |

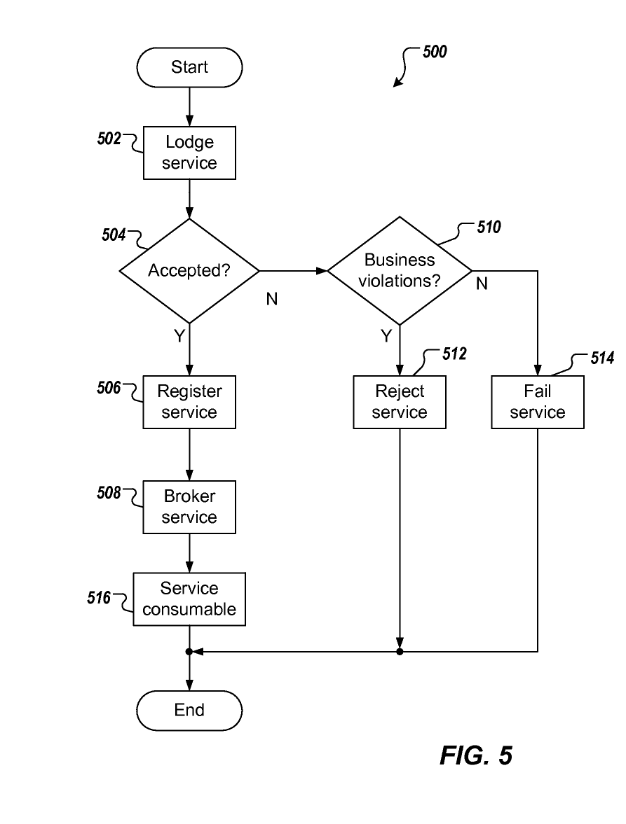

FIG. 5 is a flowchart of an example SPLM process that can be implemented in accordance with the present disclosure. A service package is assembled and is transitioned to the Lodged state (e.g., at the service broker) (502). It can be determined whether the service package is accepted (504). In some examples, the service package is not accepted as a result on component errors. In some examples, the service package is not accepted as a result of standard violations or other deficiencies. If the service package is not accepted, it is determined whether the service package violates any serious business standards (510). If the service package violates one or more serious business standards (e.g., is included within a blacklist), the service package is transitioned to the Rejected state (512) and the SPLM process 500 ends. If the service package does not violate any serious business standards (e.g., was not accepted due to one or more minor errors, the service package is transitioned to the Failed state (514), and the SPLM process 500 ends.

If the service package is accepted (i.e., the service package is cleared by an authority of the network), and the service package is transitioned to the Registered state (506). In the Registered state, the service provider may update the configuration of the service package, upon which a new provisioning version of the service package can be generated, and the service package is transitioned to the Brokered state (508). In some implementations, once the service package is at the Brokered state, the value co-creation process of the service can be performed, and the service package can be transitioned to the Consumable state (516) (i.e., is made available for end user consumption) and the SPLM process 500 ends.

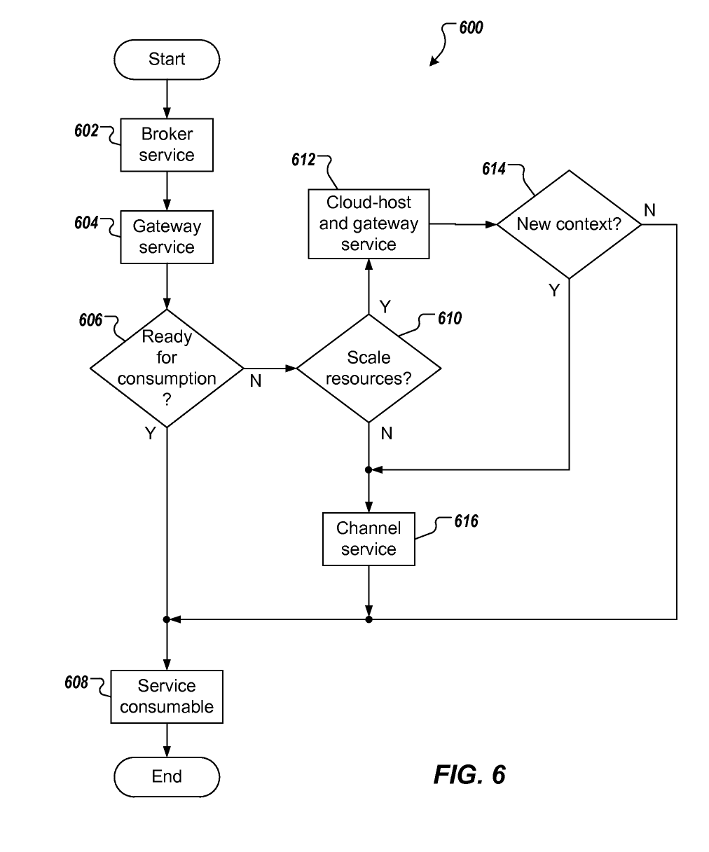

FIG. 6 is a flowchart of an example SPLM process 600 that can be implemented in accordance with the present disclosure. In some implementations, the service package is transitioned to the Brokered state (602). In some examples, the service provider can perform operations including generating an adapter for the service package, selecting a matching interoperability gateway, configuring a deployment for the adapted service package, and repackaging the adapted service package. Once the adapted service package is uploaded to the provisioning platform, the service package can be transitioned to the Gatewayed state (604). It is determined whether the service package is ready for consumption (706). If the service package is ready for consumption, the service package is transitioned to the Consumable state (608) (i.e., is made available for end user consumption) and the SPLM process 600 ends.

If the service package is not ready for consumption, it can be determined whether computing resources supporting the service are to be scaled (610). If the resources are not to be scaled up, the service package is transitioned to the Channeled state (604). From the Channeled state, the service package can be transitioned to the Consumable state (608) (i.e., is made available for end user consumption) and the SPLM process 600 ends.

If the resources are to be scaled up, the service provider can select a suitable cloud computing infrastructure and generate a deployment configuration for the service package. The service package is uploaded to the service broker and is transitioned to the Cloud-hosted and Gatewayed state (612). In some examples, it is further determined whether the service package is to be adapted for a new context (614). If the service package is to be adapted for a new context, a partner of the service provider can adapt a user interface or other structure of the service package, and the service package can be transitioned to the Channeled state (716). If the service package is not to be adapted for a new context, the service package is transitioned to the Consumable state (608).

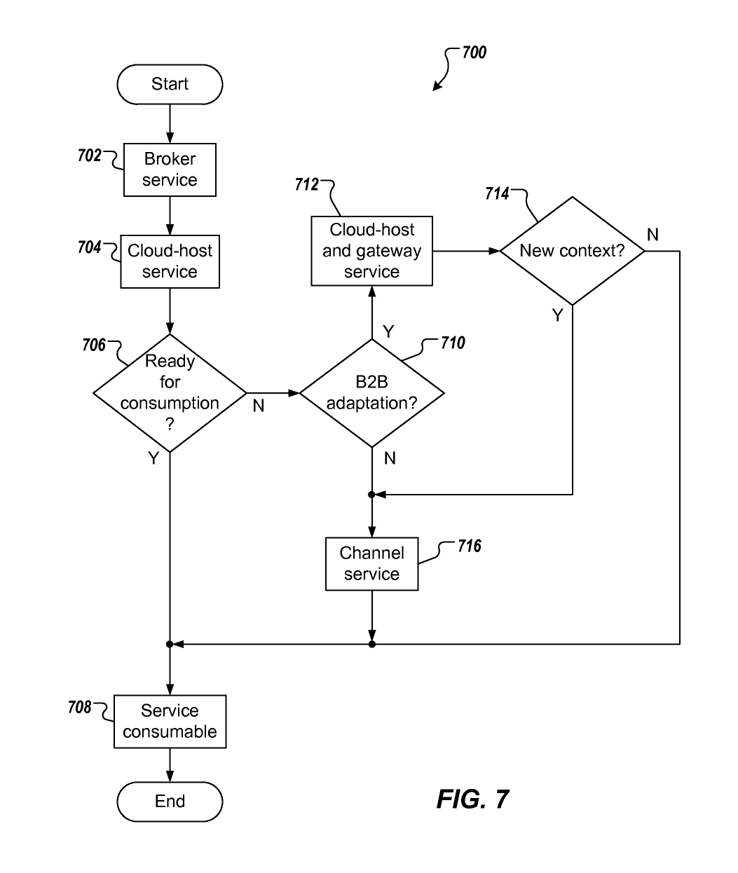

FIG. 7 is a flowchart of an example SPLM process 700 that can be implemented in accordance with the present disclosure. In some implementations, the service package is transitioned to the Brokered state (702). The service provider can perform operations including, for example, determining that the computing resources need to be scaled up in order to administer the service package, selecting a suitable cloud computing infrastructure, and generating a deployment configuration for the service package. The service package can be uploaded to the service broker and transitioned to the Cloud-hosted state (704). It is determined whether the service package is ready for consumption (706). If the service package is ready for consumption, the service package is transitioned to the Consumable state (708) (i.e., is made available for end user consumption) and the SPLM process 700 ends.

If the service package is not ready for consumption, it can be determined whether an adaptation is to be performed (e.g., adapting one or more interfaces for a business-to-business (B2B) consumption) (710). If an adaptation is not to be performed, the service package is transitioned to the Channeled state (704). From the Channeled state, the service package can be transitioned to the Consumable state (708) (i.e., is made available for end user consumption) and the SPLM process 700 ends.

If an adaptation is to be performed, the service provider can perform operations including, for example, generating an adapter for the service package, selecting a matching interoperability gateway, configuring a deployment for the adapted service package, and repackaging the adapted service package. The adapted service package can uploaded to the service provisioning platform, and the service package can be transitioned to the Cloud-hosted and Gatewayed state (712). In some examples, it is further determined whether the service package is to be adapted for a new context (714). If the service package is to be adapted for a new context, a partner of the service provider can adapt a user interface or other structure of the service package, and the service package can be transitioned to the Channeled state (716). If the service package is not to be adapted for a new context, the service package is transitioned to the Consumable state (708).

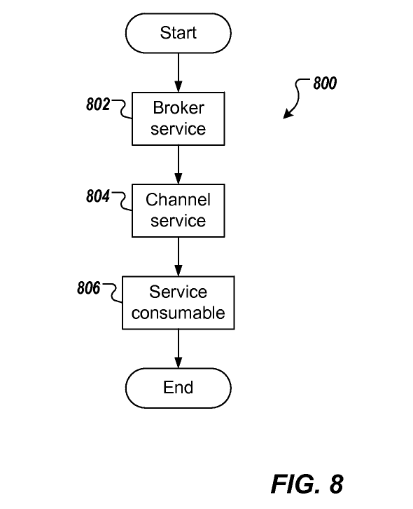

FIG. 8 is a block diagram 800 of an example SPLM process 800 that can be implemented in accordance with the present disclosure. In some implementations, the service package is transitioned to the Brokered state (802). The service provider can determine that the service package needs to be adapted for a new context. In this case, a partner of the service provider can adapt a user interface or other structure of the service package, and the service package can be transitioned to the Channeled state (804). In some examples, the value co-creation process of the service package can be performed, and the service package can be transitioned to the Consumable state (806).

In some implementations, one or more computer-implemented software tools (e.g., Eclipse-based tools) can be provided for integrated management of service provisioning. In some examples, the tools enable a service provider to manage different service entities and their dependencies that may potentially be published on different service networks. These management activities may include one or more of creation, editing, and assembly of the service artifacts as defined in the update semantics of the current provisioning state of the service. Furthermore, using the tools, the service provider can monitor the status of the service entities and trigger state transitions.

In some implementations, the service provisioning workbench includes a set of perspectives that group and emphasize views and additional functionality relevant to a specific work step. These perspectives include a Service Engineering Perspective, a Service Provisioning Perspective, and one or more other perspectives specific to certain lifecycle state transitions. In some examples, the Service Engineering Perspective can provide the starting point for a new service to enter the provisioning lifecycle. In some implementations, the Service Provisioning Perspective can provide an overview of the provisioned services and their lifecycle states and further provide general lifecycle management functionality.

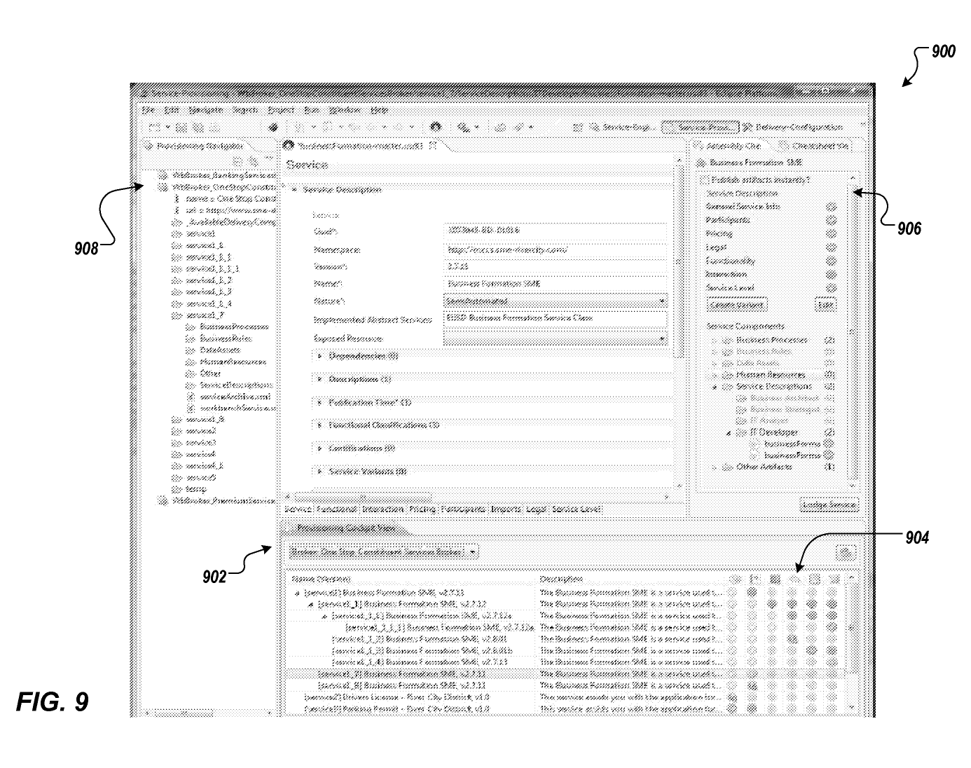

Referring now to FIG. 9, the Service Provisioning Perspective provides access to the central point of service provisioning lifecycle management. The provisioning cockpit 902 displayed at the bottom of the workbench provides an overview of the service entities being provisioned on a particular service broker or service network. In some examples, a current provisioning state and status is illustrated by the table entries 904 on the right of the provisioning cockpit 902, where each table column can represent one of the steps defined in the provisioning lifecycle. In some examples, service dependencies are accounted for by ordering the service entities in a tree-like hierarchy. In some implementations, the provisioning cockpit 902 further provides functionality to state transitions, such as the on-boarding of a successfully registered service or the creation of a gatewayed clone of a brokered service.

The provider may be assisted in preparing and triggering such state transitions by a state-specific checklist view 906. For example, the assembly checklist 906 may assist the user in providing meta-information and artifacts associated with the lodgement and registration of the service. Such checklists may further be accompanied by cheat sheets that guide the service provider through multi-step adaptations (e.g., the creation of service variants). During a transition from one state to another state, the toolset enforces the associated update semantics. In some examples, a provisioning navigator view 908 allows the discovery of locally available service artifacts, such as a USDL editor.

In some implementations, the workbench can include state-specific perspectives that leverage execution of more complex transition tasks. For example, a Delivery Configuration Perspective may bundle views and editors that support state transition from Registered to Brokered by enabling the service provider to integrate delivery components provided by the service broker and to adapt the UI forms of the service accordingly.

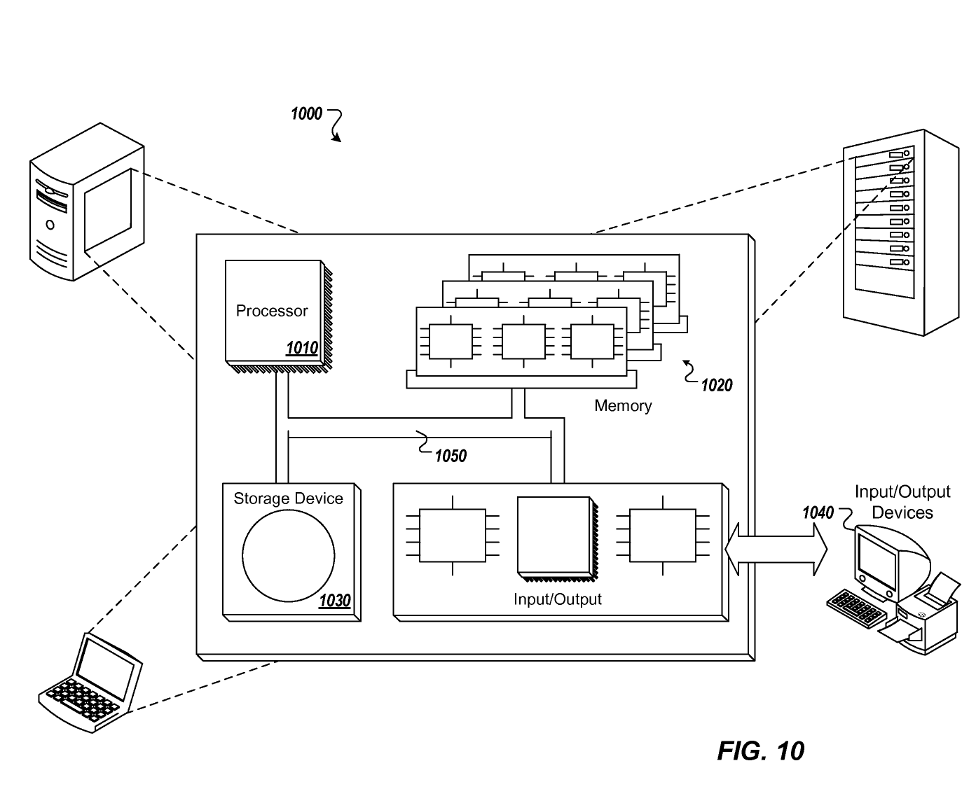

Referring now to FIG. 10, a schematic diagram of an example computing system 1000 is provided. The system 1000 can be used for the operations described in association with the implementations described herein. For example, the system 1000 may be included in any or all of the server components discussed herein. The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In one implementation, the memory 1020 is a computer-readable medium. In one implementation, the memory 1020 is a volatile memory unit. In another implementation, the memory 1020 is a non-volatile memory unit. The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device. The input/output device 1040 provides input/output operations for the system 1000. In one implementation, the input/output device 1040 includes a keyboard and/or pointing device. In another implementation, the input/output device 1040 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for lifecycle management of services provisioned in a business network, the method being executed using one or more processors and comprising:
defining a service package associated with a service, the service package being a logical representation of the service and comprising a plurality of artifacts;
storing the service package in computer-readable memory;
defining a service lifecycle model associated with the service, the service lifecycle model comprising a plurality of states;
storing the service lifecycle model in the computer-readable memory;
determining that the service is in a first state;
determining that a first set of provisioning activities has occurred;
in response to determining that the first set of provisioning activities has occurred, transitioning the service lifecycle model from the first state to a second state; and
updating the service lifecycle model in the computer readable memory.

2. The method of claim 1, wherein the first state comprises at least one of a failed state, a rejected state, a lodged state, a registered state, a brokered state, a gatewayed state, a cloud-hosted state, and a channeled state.

3. The method of claim 2, wherein the second state comprises a consumable state, in which the service is accessible to one or more end users over one or more networks.

4. The method of claim 2, wherein one or more user roles are associated with the first state, one or more users associated with each user role performs the first set of provisioning activities.

5. The method of claim 4, wherein the one or more user roles comprise a service provider role, a service hoster role, a service gateway provider role, a service broker role, and a service channel maker role.

6. The method of claim 2, wherein the first state comprises the lodged state, the first set of provisioning activities comprises acceptance of the service package and the second state comprises the registered state.

7. The method of claim 2, wherein the first state comprises the registered state, the first set of provisioning activities comprises on-boarding the service package and enriching the service package with business delivery functions, and the second state comprises the brokered state.

8. The method of claim 1, further comprising:
determining that a second set of provisioning activities has occurred; and
in response to determining that the second set of provisioning activities has occurred, transitioning the service lifecycle model to the first state.

9. The method of claim 7, wherein the first state comprises a lodged state and the second set of provisioning activities comprises assembling the service package, and uploading the service package to computer-readable storage associated with a service broker.

10. The method of claim 1, wherein the artifacts comprise at least one of a service description, implementation artifacts, interface descriptors, policies, service level agreements (SLAs), and deployment descriptors.

11. The method of claim 10, wherein the deployment descriptors comprise at least one of delivery descriptors, gatewaying descriptors, cloud deployment descriptors, and channeling descriptors.

12. The method of claim 1, wherein the first state comprises a lodged state, the first set of provisioning activities comprise determining that the service package does not conform to one or more requirements or standards, and the second state comprises one of a rejected state and a failed state.

13. The method of claim 1, further comprising:
executing a service provisioning management tool using the one or more processors; and
receiving user input from a service provider associated with the service, wherein the service lifecycle model is transitioned from the first state to the second state further in response to the user input.

14. The method of claim 13, wherein the service provisioning management tool comprises one or more of a provisioning cockpit, a state-specific checklist, and a provisioning navigator.

15. A computer-readable storage medium coupled to one or more processing devices and having instructions stored thereon which, when executed by the one or more processing devices, cause the one or more processing devices to perform operations comprising:
defining a service package associated with the service, the service package being a logical representation of the service and comprising a plurality of artifacts;
storing the service package in computer-readable memory;
defining a service lifecycle model associated with the service, the service lifecycle model comprising a plurality of states;
storing the service lifecycle model in the computer-readable memory;
determining that the service is in a first state;
determining that a first set of provisioning activities has occurred;
in response to determining that the first set of provisioning activities has occurred, transitioning the service lifecycle model from the first state to a second state; and
updating the service lifecycle model in the computer readable memory.

16. A system, comprising:
one or more computing devices; and
a computer-readable storage device coupled to the one or more computing devices and having instructions stored thereon which, when executed by the one or more computing devices, cause the one or more computing devices to perform operations comprising:
defining a service package associated with the service, the service package being a logical representation of the service and comprising a plurality of artifacts;
storing the service package in computer-readable memory;
defining a service lifecycle model associated with the service, the service lifecycle model comprising a plurality of states;
storing the service lifecycle model in the computer-readable memory;
determining that the service is in a first state;
determining that a first set of provisioning activities has occurred;
in response to determining that the first set of provisioning activities has occurred, transitioning the service lifecycle model from the first state to a second state; and
updating the service lifecycle model in the computer readable memory.
